(19) United States
(12) Patent Application Publication
(10) Pub. No.: US 2014/0307116 A1
(43) Pub. Date: Oct. 16, 2014

(54) METHOD AND SYSTEM FOR MANAGING VIDEO RECORDING AND/OR PICTURE TAKING IN A RESTRICTED ENVIRONMENT

(71) Applicant: NVIDIA CORPORATION, Santa Clara, CA (US)

(72) Inventor: Guanghua Gary ZHANG, Sunnyvale, CA (US)

(73) Assignee: NVIDIA Corporation, Santa Clara, CA (US)

(21) Appl. No.: 13/862,309

(22) Filed: Apr. 12, 2013

(51) Int. Cl. H04N 5/232; G06K 9/00

(52) U.S. Cl. CPC H04N 5/23203; G06K 9/00268; G06K 9/00456
USPC 348/211.99

(57) ABSTRACT

A system and method for initiating cooperative control over a mobile device configured to capture static images or images contained within a video sequence. The method includes obtaining an instruction on the mobile device from an external source. The method includes initiating an image controller on the mobile device, wherein the image controller controls an image capturing pipeline of the mobile device. The method includes determining that a raw image was captured by the mobile device. The method includes performing an action on the raw image based on the instruction.

### BACKGROUND

In the modern era of telecommunications, mobile devices are becoming an indispensable tool for corresponding users. For instance, in a world of users on the go, it is desired to have the ability to communicate no matter where each user is located. A well designed mobile device and corresponding communication network provides that ability to reach out to anyone at anytime and anywhere through its telecommunication capabilities.

Additionally, modern mobile devices are designed to perform multiple capabilities. With each passing year the number of capabilities for a corresponding mobile device increases. At the onset of the mobile device revolution, each mobile device was designed for one capability, and was of a large form factor. For instance, one user would own and carry a first device used for telecommunication, a second device as a camera, and a third device for gaming. As technology generations evolved, one mobile device was configured to perform at least the above mentioned tasks in a form factor that is smaller than any of the aforementioned single capability devices. In the future, it is conceivable that a mobile device could be so powerful as to encompass all electronic computing capabilities that a user would ever need in whatever form factor that is suitable for mobility and everyday use.

While the mobile device allows for users to be able to work from almost anywhere, and/or to be in contact with anyone at any time, a problem exists when a mobile device is brought into a highly sensitive or restricted area. For instance, many companies have research and development (R&D) areas that house highly guarded technology secrets. Other entities, such as, the U.S. Department of Defense have areas where national secrets are closely guarded. Further, museums may limit and control the use of photography when patrons are viewing art pieces. Still other sporting venues may want to limit and control the taking of photographs when athletes are performing, either to protect the safety of the athlete or the mark of the athlete as intellectual property.

In these aforementioned examples where there is a desire to limit the taking of photographs, authorized users/visitors to an area where photography is controlled, a full restriction on the use and carry of mobile devices may be implemented within the restricted area. In still other instances, in an effort to control the taking of photographs, an effort is made to disable and distort any photographic images taken by a mobile device may be implemented. For instance, an area containing sensitive material may be flooded with infrared lighting so that image sensors in the mobile device are overloaded with light energy thereby washing out any viewable image taken by the mobile device.

These types of controlling the taking of photographs are limiting in their scope. In the first case where the mobile device is taken away from the user while in a restricted area, users would like to continue to conduct their personal and work oriented communications (e.g., through email or telecommunications, etc.), but can't if their mobile devices were taken away. In the second case, flooding an area with infrared lighting to protect sensitive material is expensive, since lighting infrastructure must be built to protect the object containing sensitive material. Moreover, this lighting must be built for each piece of sensitive material throughout a given area or building. Further, the infrared lighting infrastructure may not be foolproof, as there are angles (such as, very acute angles) that may not be covered, thereby allowing a user to photograph sensitive material.

### SUMMARY

In embodiments of the present invention, a computer implemented method for cooperative control over an image capturing capability of an electronic device that is configured to capture static images or images contained within a video sequence. The method includes obtaining an instruction on the mobile device from an external source. The method includes initiating an image controller on the mobile device, wherein the image controller controls an image capturing pipeline of the mobile device. The method includes determining that a raw image was captured by the mobile device. The method includes performing an action on the raw image based on the instruction.

In other embodiments of the present invention, a non-transitory computer-readable medium is disclosed having computer-executable instructions for causing a computer system to perform a method for cooperative control over an image capturing capability of an electronic device that is configured to capture static images or images contained within a video sequence. The method includes obtaining an instruction on the mobile device from an external source. The method includes initiating an image controller on the mobile device, wherein the image controller controls an image capturing pipeline of the mobile device. The method includes determining that a raw image was captured by the mobile device. The method includes performing an action on the raw image based on the instruction.

In still other embodiments of the present invention, a computer system is disclosed comprising a processor and memory coupled to the processor and having stored therein instructions that, if executed by the computer system, cause the computer system to execute a method for cooperative control over an image capturing capability of an electronic device that is configured to capture static images or images contained within a video sequence. The method includes obtaining an instruction on the mobile device from an external source. The method includes initiating an image controller on the mobile device, wherein the image controller controls an image capturing pipeline of the mobile device. The method includes determining that a raw image was captured by the mobile device. The method includes performing an action on the raw image based on the instruction.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts a block diagram of an exemplary computer system suitable for implementing the present methods, in accordance with one embodiment of the present disclosure.

FIG. 2 is a block diagram of an environment in which cooperative control is implemented over an image capturing capability of an electronic device that is configured to capture static images or images contained within a video sequence, in accordance with one embodiment of the present disclosure.

FIG. 3A is a flow diagram illustrating a method for taking an action on an electronic device, in accordance with one embodiment of the present disclosure.

FIG. 3B is a flow diagram illustrating a method for cooperative control over an image capturing capability of an electronic device that is configured to capture static images or images contained within a video sequence, in accordance with one embodiment of the present disclosure.

FIG. 4 is a flow diagram illustrating a method of isolating features within an image and performing actions on those features, wherein the method is implemented within an image capturing pipeline of an electronic device configured with cooperative control over its image capturing capability, in accordance with one embodiment of the present disclosure.

FIG. 5A is a diagram of an image including a feature that is identified as including sensitive material in an image captured by an electronic device that is configured for cooperative control over its image capturing capabilities, in accordance with one embodiment of the present disclosure.

FIG. 5B is a diagram of the image in FIG. 5A, wherein the feature is distorted before storing the image within an electronic device that is configured for cooperative control over its image capturing capabilities, in accordance with one embodiment of the present disclosure.

FIG. 6A is a diagram illustrating the implementation of a blurring technique to distort an identified feature within a region of an image captured by an electronic device that is configured for cooperative control over its image capturing capabilities, in accordance with one embodiment of the present disclosure.

FIG. 6B is a diagram illustrating the implementation of a pixilation technique to distort an identified feature within a region of an image captured by an electronic device that is configured for cooperative control over its image capturing capabilities, in accordance with one embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

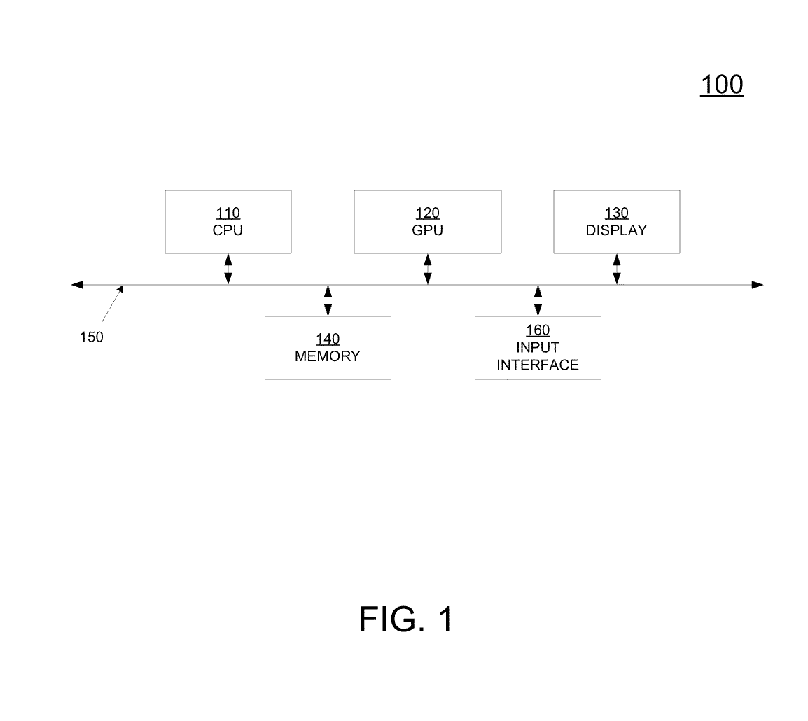

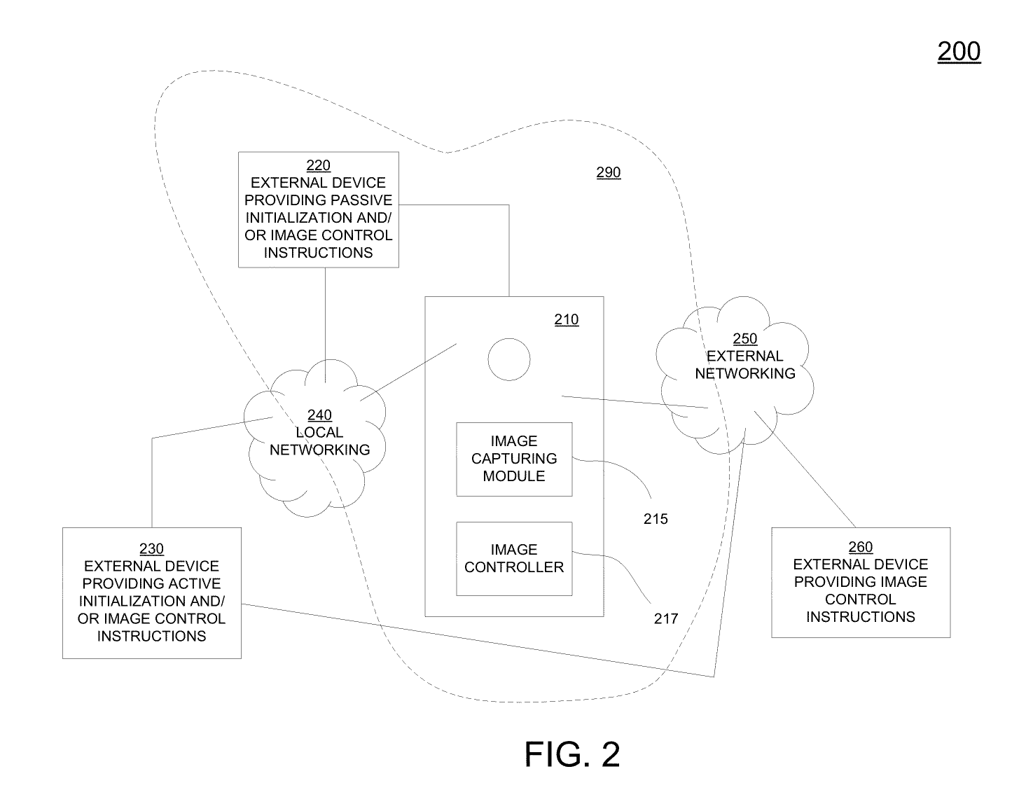

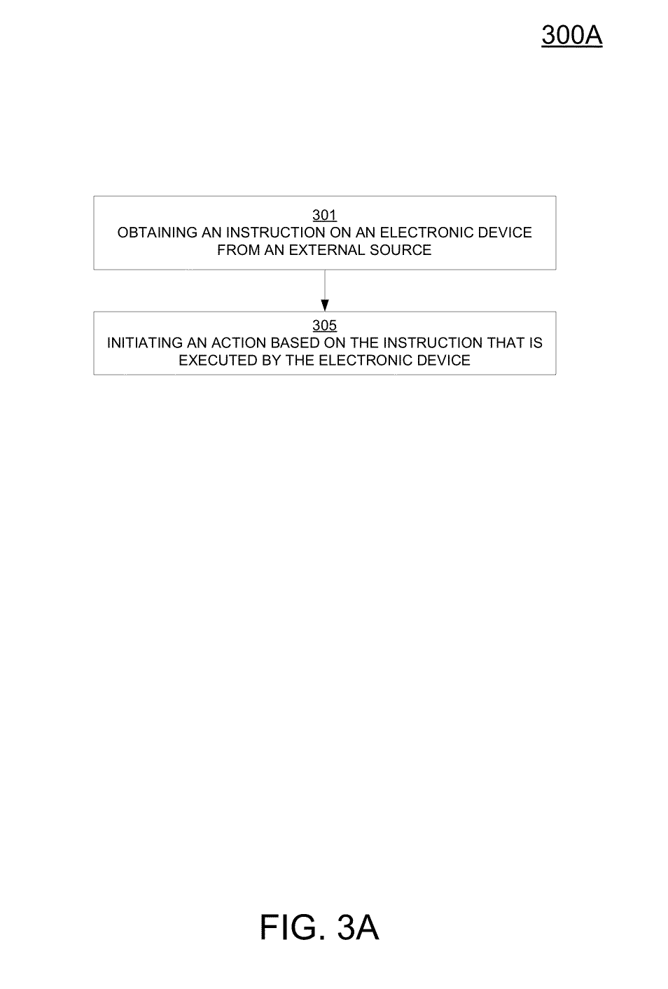

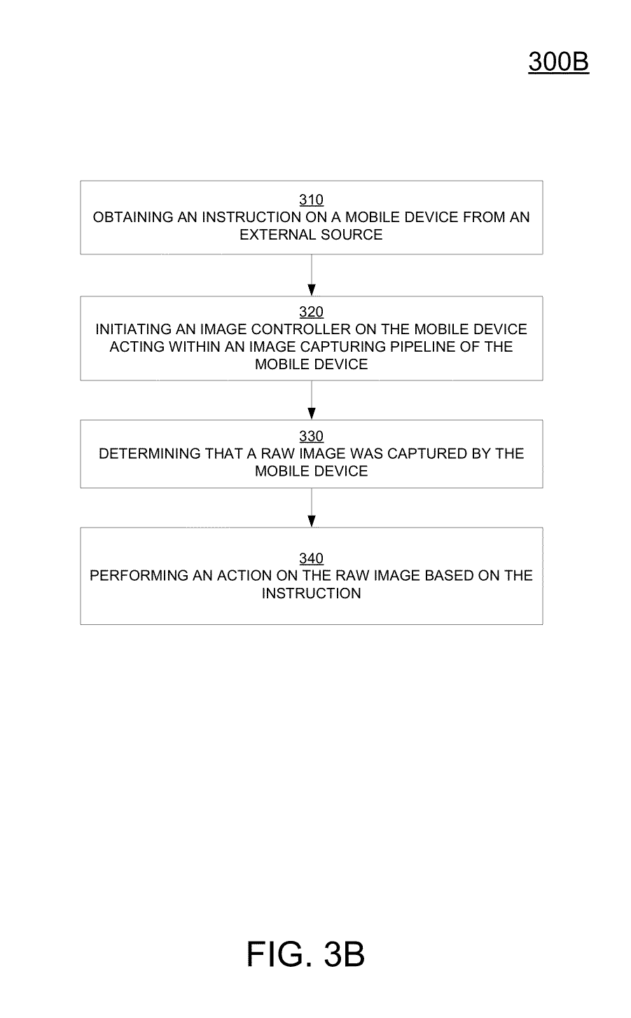

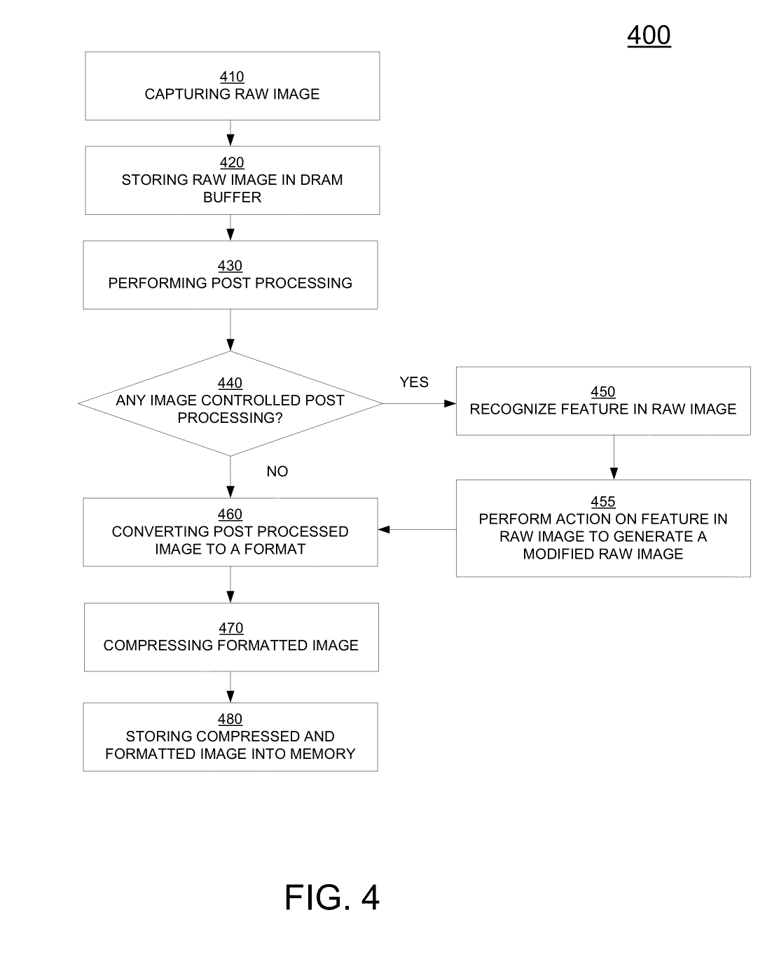

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “obtaining,” “initiating,” “determining,” “performing,” “accessing,” or the like, refer to actions and processes (e.g., flowcharts 300A, 300B, and 400 of FIGS. 3A, 3B, and 4, respectively) of a computer system or similar electronic computing device or processor (e.g., system 100 and mobile computing device 210 of FIGS. 1 and 2, respectively). The computer system or similar electronic computing device manipulates and transforms data represented as physical (electronic) quantities within the computer system memories, registers or other such information storage, transmission or display devices.

FIGS. 3A, 3B, and 4 are flowcharts of examples of computer-implemented methods for cooperative control over an image capturing capability of an electronic device that is configured to capture static images or images contained within a video sequence according to embodiments of the present invention. Although specific steps are disclosed in the flowcharts, such steps are exemplary. That is, embodiments of the present invention are well-suited to performing various other steps or variations of the steps recited in the flowcharts.

Other embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 1 is a block diagram of an example of a computing system 100 capable of implementing embodiments of the present disclosure. Computing system 100 broadly represents any single or multi-processor computing device or system capable of executing computer-readable instructions. Examples of computing system 100 include, without limitation, workstations, laptops, client-side terminals, servers, distributed computing systems, handheld devices, or any other computing system or device. In its most basic configuration, computing system 100 may include at least one processor 110 and a system memory 140.

Both the central processing unit (CPU) 110 and the graphics processing unit (GPU) 120 are coupled to memory 140. System memory 140 generally represents any type or form of volatile or non-volatile storage device or medium capable of storing data and/or other computer-readable instructions. Examples of system memory 140 include, without limitation, RAM, ROM, flash memory, or any other suitable memory device. In the example of FIG. 1, memory 140 is a shared memory, whereby the memory stores instructions and data for both the CPU 110 and the GPU 120. Alternatively, there may be separate memories dedicated to the CPU 110 and the GPU 120, respectively. The memory can include a frame buffer for storing pixel data drives a display screen 130.

The system 100 includes a user interface 160 that, in one implementation, includes an on-screen cursor control device. The user interface may include a keyboard, a mouse, and/or a touch screen device (a touchpad).

CPU 110 and/or GPU 120 generally represent any type or form of processing unit capable of processing data or interpreting and executing instructions. In certain embodiments, processors 110 and/or 120 may receive instructions from a software application or hardware module. These instructions may cause processors 110 and/or 120 to perform the functions of one or more of the example embodiments described and/or illustrated herein. For example, processors 110 and/or 120 may perform and/or be a means for performing, either alone or in combination with other elements, one or more of the monitoring, determining, gating, and detecting, or the like described herein. Processors 110 and/or 120 may also perform and/or be a means for performing any other steps, methods, or processes described and/or illustrated herein.

In some embodiments, the computer-readable medium containing a computer program may be loaded into computing system 100. All or a portion of the computer program stored on the computer-readable medium may then be stored in system memory 140 and/or various portions of storage devices. When executed by processors 110 and/or 120, a computer program loaded into computing system 100 may cause processor 110 and/or 120 to perform and/or be a means for performing the functions of the example embodiments described and/or illustrated herein. Additionally or alternatively, the example embodiments described and/or illustrated herein may be implemented in firmware and/or hardware.

Embodiments of the present invention provide for cooperative control over an image capturing capability of an electronic device that is configured to capture static images or images contained within a video sequence. That is, a user cooperates with the system and/or environment so that an image capturing capability of his or her mobile electronic device is controlled by the environment and/or external devices within that environment. In that manner, even though the user is in a restricted area with sensitive material, that user is still able to use and fully control his or her mobile device for various capabilities other than the controlled image capturing capability.

While embodiments of the present invention are described within the context of mobile electronic devices, or mobile devices, it is intended that the cooperative control over image capturing capabilities is implementable within any type of electronic device configured to capture images or images contained within a video sequence. Still other embodiments are capable of implementing any type of cooperative control over an electronic device, such as, providing authorization, opening doors, etc.

FIG. 2 is a block diagram of a network environment 200 in which cooperative control is implemented over an image capturing capability of a mobile device 210, in accordance with one embodiment of the present disclosure. The mobile device 210 is capable of implementing cooperative control over an image capturing capability of an electronic device that is configured to capture static images or images contained within a video sequence. The mobile device 210 includes an image capturing module 215 that is configured to capture static images and images contained within a video sequence. Further, the mobile device 210 includes an image controller 217 that is configured to control the image capturing capabilities of the mobile device 210.

For purposes of illustration only, a use condition in which the image capturing capabilities of the mobile device 210 is cooperatively controlled is described. For instance, a user enters into a restricted area 290 and is carrying a mobile device 210, such as, a mobile phone. The restricted area may be an R&D facility, a government entity with need for photographic security, museums, sporting venues, etc. The user cooperates with the environment, and more specifically, external sources and/or devices within the restricted area 290 in order to initiate an image controller function (by image controller 217) over an image capturing capability (by module 215) of the mobile device 210. The point illustrated is that the user cooperatively begins actions that initiate control over the image capturing capabilities of a corresponding mobile device 210.

In one embodiment, the user may scan an external device 220 providing passive initialization and/or image control instructions. For instance, the user may scan a scannable object (e.g., bar code, Aztec code, etc.) 220 that is within the restricted area 290. The scannable object may provide all the image control instructions, or provide initialization instructions to facilitate communication between the mobile device 210 and an external device 230 through a local network 240 and/or an external network 250. As an example, the scannable object 220 may provide instructions for the mobile device 210 to establish communications with the external device 230 (e.g., through a web link) locally through the local network 240, or to an external device 260 (e.g., through a web link) as facilitated by the external network 250.

In another embodiment, image and video control instructions for a mobile device are delivered verbally and interpreted through a voice recognition system (e.g., Siri for Apple iOS compatible systems). For example, any method enabling the delivery of the instructions to the mobile device 210 is implemented. For instance, a placard providing verbal instructions may be placed inside the entry to a restricted area, and the user may audibly direct those verbal instructions to the mobile device 210. In another instance, a system may recognize whenever a user enters into a restricted area, and upon that recognition plays the instruction over a speaker system so that image and video control features are activated on the mobile device 210.

As still another example, a user may cooperatively establish near field communications (NFC) between the external device 220 and mobile device 210, or external device 230 and mobile device 210. NFC provides for mobile devices to establish radio communication with other similarly configured devices by touching them together or bringing them into close proximity of each other. In this case, the user would enter the restricted area, and cooperatively initiate control over his or her mobile device 210 by establishing NFC communication with the external device 220 either directly or through a local network 240. For instance, by initiating the NFC communication between the external device 220 and the mobile device 210, a request for an instruction is delivered to the external device 220. In one case, external device 220 may provide to the mobile device each of the initialization and image control instructions. In another case, the external device may provide only the initialization instructions, which directs the mobile device to establish communication with external device 230 or 260 either through the local network 240 or external network 250 to receive image control instructions.

In still another example, the external device 230 broadcasts through local network 240 a searching signal to actively determine whether any mobile devices (e.g., device 210) has entered the restricted region 290. For instance, the searching signal is broadcasted over the local network 240 (e.g., radio, Wi-Fi, radio frequency identification-RFID, wireless service carriers, etc.) by the external device 230 and received by mobile device 210. Once the searching signal is successfully received and processed, communication is established between the external device 230 and the mobile device 210 to provide initialization and/or image control instructions to the mobile device 210 through the local network 240.

FIG. 3A is a flow diagram 300A illustrating a method for initiating an action on an electronic device, in accordance with one embodiment of the present disclosure. In another embodiment, flow diagram 300A illustrates a computer implemented method for initiating an action on an electronic device. In still another embodiment, flow diagram 300A is implemented within a computer system including a processor and memory coupled to the processor and having stored therein instructions that, if executed by the computer system causes the system to execute a method for initiating an action on an electronic device. In still another embodiment, instructions for performing a method are stored on a non-transitory computer-readable storage medium having computer-executable instructions for causing a computer system to perform a method for initiating an action on an electronic device. The method outlined in flow diagram 300A is implementable by one or more components of the computer system 100 and 210 of FIGS. 1 and 2, respectively.

At 301, the method includes obtaining an instruction on an electronic device from an external source. As previously described, the external source includes a passive device or object (e.g., scannable object) that is configured to relay the instruction to the mobile device. For instance, once scanned, a scannable object provides the instruction to the mobile device. In another instance, the passive device includes an NFC device, which when activated provides the instruction to the mobile device. In still another instance, the instruction is actively delivered to the electronic device. That is, the external source includes an active device that provides the instruction. For instance, in one implementation, the external source continuously searches for a user and/or compatible electronic devices entering into a restricted region. As an example, the external source provides voice instructions over a speaker system at the appropriate time (e.g., once entry is detected into a restricted area).

At 305, the method includes initiating an action based on the instruction. The action is executed by the electronic device. More particularly, any action that is executable by the electronic device is initiated as triggered by the instruction. As an example, enable/disable functionality for any feature or application on the electronic device is initiated once the instruction is received. For instance, during a takeoff sequence for a commercial airliner, instructions may be provided actively or passively to one or more electronic devices located in the airliner. Once received, the instructions trigger a disabling function on the electronic device, such that the device is shut off. In other instances, only the radio communication or voice recording functionality is shut off. Other actions are fully supported in other embodiments of the present invention.

FIG. 3B is a flow diagram 300B illustrating a method for cooperative control over an image capturing capability of an electronic device that is configured to capture static images or images contained within a video sequence, in accordance with one embodiment of the present disclosure. In still another embodiment, flow diagram 300B illustrates a computer implemented method for cooperative control over an image capturing capability of an electronic device that is configured to capture static images or images contained within a video sequence. In another embodiment, flow diagram 300B is implemented within a computer system including a processor and memory coupled to the processor and having stored therein instructions that, if executed by the computer system causes the system to execute a method for cooperative control over an image capturing capability of an electronic device that is configured to capture static images or images contained within a video sequence. In still another embodiment, instructions for performing a method are stored on a non-transitory computer-readable storage medium having computer-executable instructions for causing a computer system to perform a method for cooperative control over an image capturing capability of an electronic device that is configured to capture static images or images contained within a video sequence. The method outlined in flow diagram 300B is implementable by one or more components of the computer system 100 and 210 of FIGS. 1 and 2, respectively.

At 310, the method includes obtaining an instruction on a mobile device from an external source. As previously described, the external source includes a passive device or object (e.g., scannable object) that is configured to relay the instruction to the mobile device. For instance, once scanned, a scannable object provides the instruction to the mobile device. In another instance, the passive device includes an NFC device, which when activated provides the instruction to the mobile device.

In another embodiment, the external source includes an active device that provides the instruction. For instance, in one implementation, the external source continuously searches for compatible devices entering into a restricted region. Once the external source determines that a mobile device has entered the region, and is configured for image control, then the external source delivers the instruction to the mobile device. The instruction is related to providing control over the image capturing capabilities of the mobile device. For instance, the instruction may include initiation and/or image control instructions, or instructions for implementing initiation and/or image control.

At 320, the method includes initiating an image controller on the mobile device that is configured to act within an image capturing pipeline. The image capturing pipeline includes a set of instructions, operations, and/or components that are used to capture an image within the mobile device. A general description of the image capturing pipeline is provided in FIG. 4. More specifically, the image controller (e.g., controller 217 of FIG. 2) is capable of controlling instructions within the pipeline, either by a combination of adding, avoiding, and/or modifying instructions within the existing pipeline in order to provide cooperative control over the image capturing capability.

In one embodiment, the initiation sequence includes determining which actions that need to be taken on an image, as implemented within the pipeline. The instruction received in 310 provides additional information relating to the specific actions necessarily taken by the mobile device within its image capturing pipeline. For instance, the image capturing instruction provides varying levels of control over any captured image, as will be further described below.

Once the initiation process is completed, the mobile device is now configured to take certain predefined actions, based on the instruction, on any image taken by the mobile device. In particular, at 330, the method includes determining that a raw image was captured by the mobile device. The raw image is defined as the unprocessed set of pixels delivered directly from the one or more image sensors used by the mobile device. Information contained in the raw image is typically stored in random access memory (e.g., dynamic random access memory—DRAM), and retrieved to perform additional post-processing operations before storing into memory.

At 340, the method includes performing an action on the raw image based on the instruction. More specifically, the post-processing operations include operations that are performed based on the instruction provided in 310. A more detailed description on what types of actions are performed in various embodiments is provided in relation to FIG. 4. For instance, some post-processing steps include removal of defective pixels, white balancing used for accounting for color temperature of one or more light sources used to take the image, demosaicing used for interpolating the raw data into a matrix of colored pixels, noise reduction, color translation to convert a devices native color space into an output color space, tone reproduction rendering to provides for pleasing effects and correct viewing on low-dynamic range of the viewing platform, and compression used for compressing the processed image into a compressed file.

FIG. 4 is a flow diagram 400 illustrating a computer implemented method of isolating features within an image and performing actions on those features, wherein the method is implemented within an image capturing pipeline of an electronic device configured with cooperative control over its image capturing capability, in accordance with one embodiment of the present disclosure.

In another embodiment, flow diagram 400 is implemented within a computer system including a processor and memory coupled to the processor and having stored therein instructions that, if executed by the computer system causes the system to execute a method of isolating features within an image and performing actions on those features, wherein the method is implemented within an image capturing pipeline of an electronic device configured with cooperative control over its image capturing capability. In still another embodiment, instructions for performing a method as illustrated in flow diagram 400 are stored on a non-transitory computer-readable storage medium having computer-executable instructions for causing a computer system to perform a method of isolating features within an image and performing actions on those features, wherein the method is implemented within an image capturing pipeline of an electronic device configured with cooperative control over its image capturing capability. The method outlined in flow diagram 400 is implementable by one or more components of the computer system 100 and 210 of FIGS. 1 and 2, respectively. In another embodiment, flow diagram 400 is implemented in conjunction with flow diagram 300A and/or 300B.

As shown in FIG. 2, pipeline operations include 410, 420, 430, 460, 470, and 480 used to capture an image and store that image within a corresponding mobile device. Additional operations are included when an image controller acts within the pipeline operations. For instance, the image controller inserts operations 440, 450, and 455 into the image capturing pipeline when active. The operations in the pipeline of FIG. 4 (e.g., 410, 420, 430, 460, 470, and 480) are described generally. Additional operations or more detailed operations may be performed in a pipeline that is used in conjunction with elements of embodiments of the present invention.

At 410, the method includes capturing a raw image by the corresponding mobile device. In one implementation, the raw image is a proprietary format used by the mobile device to capture unprocessed set of pixel data directly from the one or more image sensors. In another implementation, the raw image is a standard format.

At 420, the method includes storing the raw image in a buffer, such as, a DRAM buffer. In that manner, the raw image is accessed and used when performing post processing operations at 430. For instance, post-processing operations include coloring filtering (e.g., Bayer filter) is performed to interpolate the raw data/image into a mosaic or matrix of colors. In some implementations, that mosaic is further converted into a standard red, green, and blue (RGB) format. Additional post-processing operations include white balancing, noise reduction, color translation, tone reproduction, etc.

The method includes at 440, determining whether any image controlled post processing operations are necessary. That is, if the mobile device has cooperatively initiated control over its image capturing capabilities, then additional post processing operations are included within the image capturing pipeline, and the method of flow diagram 400 proceeds to 450. On the other hand, if the mobile device has not initiated control over its image capturing capabilities, then the process of flow diagram 400 proceeds to 460. In either case, the remaining steps of the image capturing pipeline are performed. For instance, at 460 the post processed image is converted to a particular format to generate a formatted image. Included within or in addition to, at 470, the modified raw image is compressed using a compression format to generate a compressed, modified raw image. At 470, the compressed, modified raw image is stored into memory.

Returning to the operations performed when image control is implemented, at 450, the method includes recognizing a feature in the raw image. For instance, the raw image is accessed from a buffer, such as DRAM, in the mobile device. A feature is identified that is captured in the raw image. That is, somewhere in the post-processing steps, feature recognition is performed and that the feature was captured in the raw image. In one implementation, feature recognition is provided within the image capturing capabilities of the mobile device. In other implementations, feature recognition is provided within the pipeline by an additional module having those capabilities. Some features include a face, text, a particular language, special visual signatures (e.g., color, texture, geometric shapes, or primitives), and logos. In one embodiment, a feature includes any searchable, recognizable, and/or definable object.

Feature recognition is based on the instruction received by the mobile device at 310, for example. That is, the feature is environment specific, such that in one restricted area a first feature is preselected as containing sensitive information, whereas in another restricted area a second feature is preselected as containing sensitive information. In still other embodiments, one or more features are selected as containing sensitive information.

At 455, the method includes performing an action based on the instruction to distort the feature and generate a modified raw image. The modified raw image, if viewed would have the distorted feature within the image, instead of the original portrayal of the feature. Thereafter, the process returns back to the image capturing pipeline at operation 460.

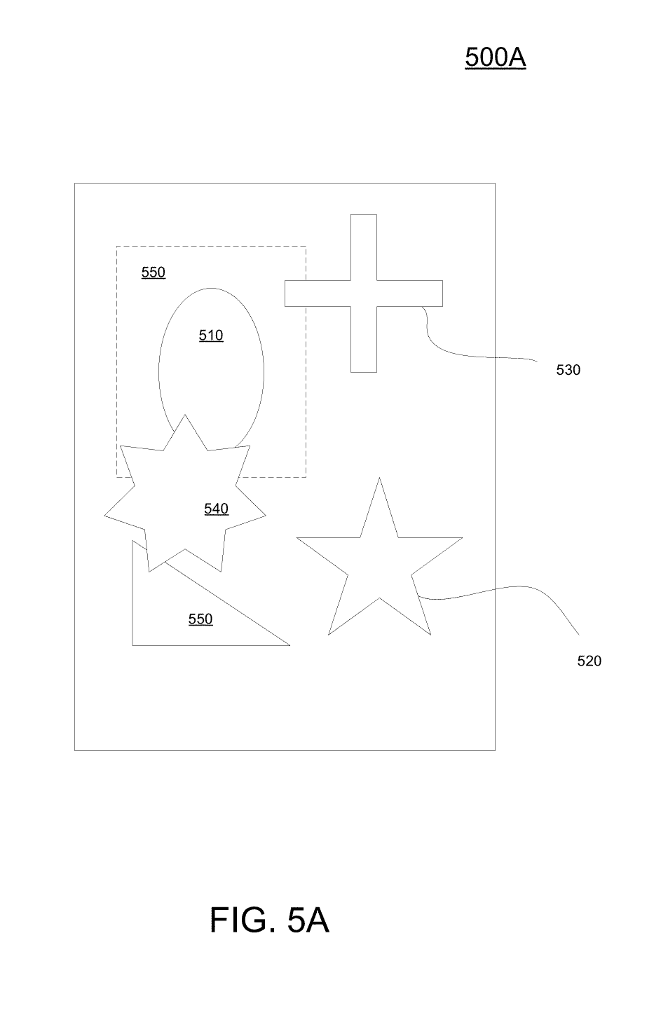

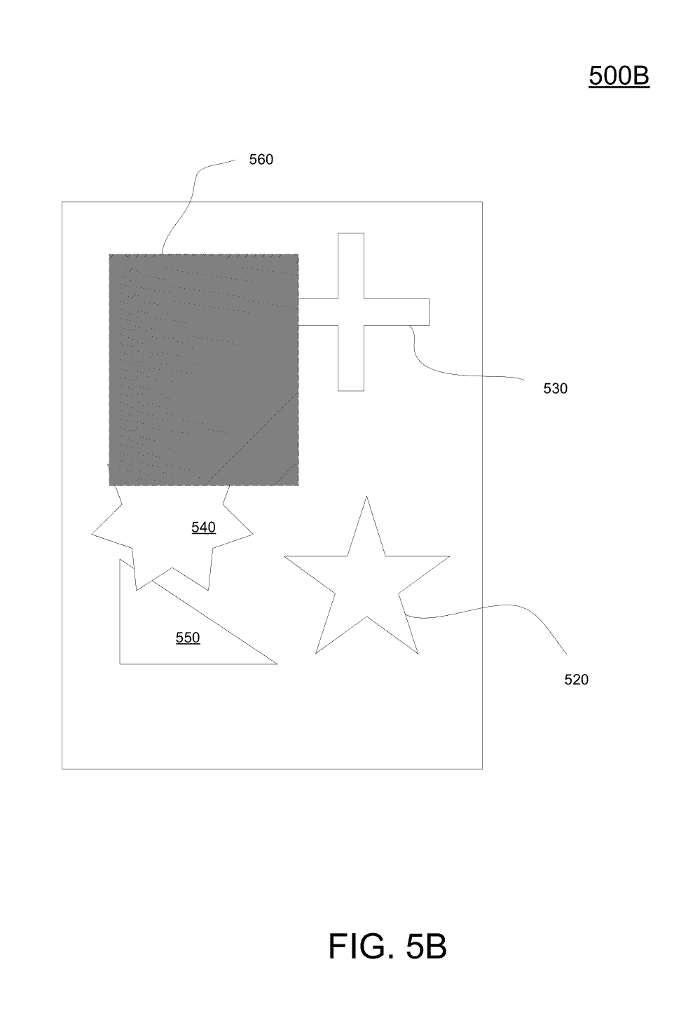

For instance, in one embodiment, a region 550 in the raw image 500A is determined, wherein the region includes a predefined feature. FIG. 5A is a diagram of an image including a feature 510 that is identified as including sensitive material in an image captured by an electronic device that is configured for cooperative control over its image capturing capabilities, in accordance with one embodiment of the present disclosure. As shown, region 550 is shown and identified as including the feature 510, represented as an oval. The oval feature 510 is representative of any type of sensitive information, such as, a searchable object, text, face, languages, logos, etc. Additional objects are included within image 550B, such as, a seven point star 540 that partly intrudes into region 550, and is shown overlaying feature 510. Also, a triangle feature 550, a five point star 520 and a cross 530 are shown in image 550B. these objects are representative of any object found in an image containing non-sensitive information.

In embodiments, the method includes determining a region that includes the feature. After the region is determined, various levels of control are implemented for distorting the feature, such as, disabling the video recording and image taking functions on the mobile device, blacking out regions of interest, blurring or smearing the region of interest, and performing decimation or pixilation to render the video/image a significant loss of detail in the region of interest.

For example in one embodiment, the method includes determining a region that includes the feature. After the region is determined, the action used for distorting the feature includes blacking out the corresponding region in the modified raw image. For illustration, FIG. 5B is a diagram of the image 500A after post processing, wherein the feature is distorted before storing the modified raw image within an electronic device that is configured for cooperative control over its image capturing capabilities, in accordance with one embodiment of the present disclosure. As shown, image 500B includes a blackened out region 560, wherein pixels in region 550 of FIG. 5A are rendered as black in the image 500B of FIG. 5B. In that manner, feature 510 is entirely distorted. Since feature 540 is included both inside and outside region 590, that portion of feature 540 included within region 590 is also blackened out.

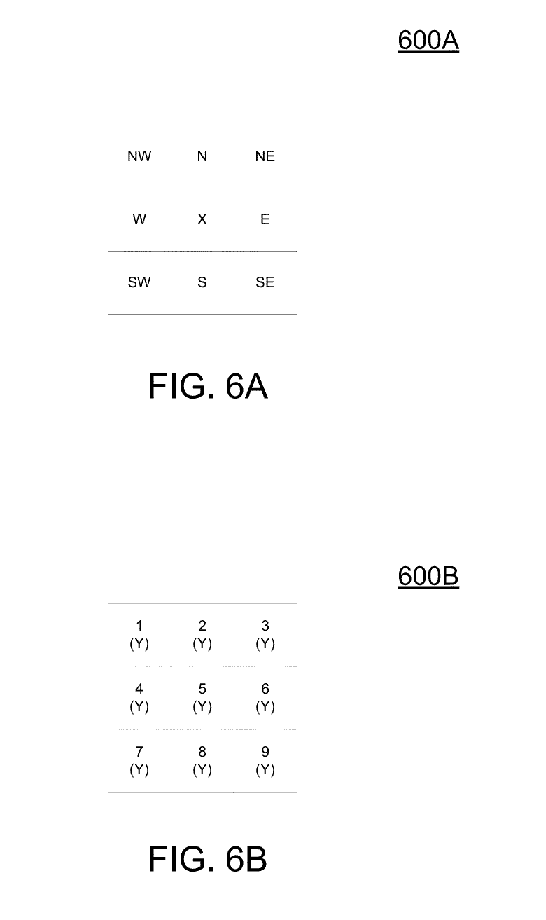

Other embodiments are well suited to using different distortion techniques. For instance, in one embodiment, a corresponding region is blurred in the modified raw image. That is every pixel in the region takes on a blurred pixel value. FIG. 6A is a diagram illustrating the implementation of a blurring technique to distort an identified feature within a region or portions of a region 600A of a raw image (e.g., image 500A) captured by an electronic device that is configured for cooperative control over its image capturing capabilities, in accordance with one embodiment of the present disclosure. As shown, the region includes nine pixels, a center pixel “X” and eighth surrounding pixels, including “N”, “NE”, “E”, “SE”, “S”, “SW”, “W”, and “NW” pixels. A pixel value for the center pixel “X” is determined by taking the average of pixel values of its surrounding pixels. For instance, if the pixel values indicate color values, then the blurring technology would determine the average of color values for each of the eighth surrounding pixels, and assign the average to the center pixel “X”. The same process is performed for determining the color value of the pixel “E”, except that the set of surrounding pixels will have shifted to the right by one pixel. In that manner, the feature shown is distorted through blurring.

In still another embodiment, a corresponding region is pixilated in the modified raw image to reduce resolution. That is every pixel in the region takes on a pixilated value. FIG. 6B is a diagram illustrating the implementation of a pixilation technique to distort an identified feature within a region or portion of region 600B of an image captured by an electronic device that is configured for cooperative control over its image capturing capabilities, in accordance with one embodiment of the present disclosure. As shown, the region or portion of region 600B includes nine pixels numbered 1 through 9 in one embodiment, though other embodiments may include more or less pixels arranged in various shapes. In one instance, color values are assigned to each pixel in the region or portion of region 600B. Each of the pixels is assigned the same pixilated color value (“Y”) that is determined by taking the average of all the color values in a given grouping of pixels of the region or portion of region 600B. In that manner, the feature is distorted through pixilation.

Thus, according to embodiments of the present disclosure, systems and methods are described providing for cooperative control over an image capturing capability of an electronic device that is configured to capture static images or images contained within a video sequence.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the present disclosure are thus described. While the present disclosure has been described in particular embodiments, it should be appreciated that the disclosure should not be construed as limited by such embodiments, but rather construed according to the below claims.

What is claimed:

1. A method of cooperative control, comprising:
obtaining an instruction on a mobile device from an external source;
initiating an image controller on said mobile device acting within an image capturing pipeline of said mobile device;
determining that a raw image was captured by said mobile device;
performing an action on said raw image based on said instruction.

2. The method of claim 1, wherein said performing an action further comprises:
accessing said raw image from a buffer in said mobile device;
identifying a feature captured in said raw image;
performing said action to distort said feature and generate a modified raw image; and
storing a version of said modified raw image in memory of said mobile device.

3. The method of claim 2, wherein said performing said action on said feature comprises:
determining a region in said raw image comprising said feature; and
blacking out a corresponding region in said modified raw image.

4. The method of claim 2, wherein said performing said action on said feature comprises:
determining a region in said raw image comprising said feature; and
blurring a corresponding region in said modified raw image.

5. The method of claim 2, wherein said performing said action on said feature comprises:
determining a region in said raw image comprising said feature; and
performing pixilation to reduce resolution in a corresponding region in said modified raw image.

6. The method of claim 2, wherein said storing a version comprises:
compressing said modified raw image using a compression format to generate a compressed, modified raw image; and
storing said compressed, modified raw image in said memory.

7. The method of claim 1, wherein said raw image is included within a plurality of images in a video sequence taken by said mobile device.

8. The method of claim 2, wherein said feature is taken from a group consisting essentially of:
a face;
text;
languages;
logos; and
a searchable and definable object.

9. The method of claim 1, wherein said obtaining an instruction comprises:
receiving a scannable code comprising said instruction.

10. The method of claim 9, further comprising:
accessing a web site providing said instruction based on information in said scannable code.

11. The method claim 1, wherein said obtaining an instruction comprises:
sending a request for said instruction to a second device using near field communication (NFC); and
receiving said instruction from said second device.

12. The method of claim 1, wherein said obtaining an instruction comprises:
receiving a searching signal from a second device comprising said external source over a wireless network;
establishing communication with said second device; and
receiving said instruction from said second device.

13. The method of claim 1, wherein said obtaining an instruction comprises:
receiving a verbal instruction on said mobile device; and
interpreting said verbal instruction using a voice recognition system on said mobile device.

14. A non-transitory computer-readable medium having computer-executable instructions for causing a computer system to perform a method comprising:
obtaining an instruction on a mobile device from an external source;
initiating an image controller on said mobile device acting within an image capturing pipeline of said mobile device;
determining that a raw image was captured by said mobile device;
performing an action on said raw image based on said instruction.

15. The computer readable medium of claim 14, wherein said performing an action in said method further comprises:
accessing said raw image from a buffer in said mobile device;
identifying a feature captured in said raw image;
performing said action to distort said feature and generating a modified raw image; and
storing a version of said modified raw image in memory of said mobile device.

16. The computer readable medium of claim 14, wherein said storing a version in said method comprises:
compressing said modified raw image using a compression format to generate a compressed, modified raw image; and
storing said compressed, modified raw image in said memory.

17. The computer readable medium of claim 14, wherein said feature in said method is taken from a group consisting essentially of:
a face;
text;
languages;
logos; and
a searchable and definable object.

18. A computer system comprising:
a processor; and
memory coupled to said processor and having stored therein instructions that, if executed by said computer system, cause said computer system to execute a method comprising:
obtaining an instruction on a mobile device from an external source;
initiating an image controller on said mobile device acting within an image capturing pipeline of said mobile device;
determining that a raw image was captured by said mobile device; and
performing an action on said raw image based on said instruction.

19. The computer system of claim 18, wherein said performing an action in said method further comprises:
accessing said raw image from a buffer in said mobile device;
identifying a feature captured in said raw image;
performing said action to distort said feature and generating a modified raw image; and
storing a version of said modified raw image in memory of said mobile device.

20. The computer system of claim 18, wherein said feature is taken from a group consisting essentially of:
a face;
text;
languages;
logos; and
a searchable and definable object.
